(19) United States
(12) Patent Application Publication
(10) Pub. No.: US 2011/0210026 A1
(43) Pub. Date: Sep. 1, 2011

(54) SHELL FOR ELECTRONIC DEVICE AND METHOD OF FORMING THE SAME

(76) Inventors: Hongzhen Zhao, Shenzhen (CN); Mingzhu Chang, Shenzhen (CN); Jiaxin Zhang, Shenzhen (CN); Taoyong Deng, Shenzhen (CN); Xiaoqing Gao, Shenzhen (CN)

(21) Appl. No.: 13/060,362

(22) PCT Filed: Aug. 25, 2009
(86) PCT No.: PCT/CN2009/073504

§ 371 Date: Feb. 23, 2011

(30) Foreign Application Priority Data
Aug. 25, 2008 (CN) 200810210899.4

(51) Int. Cl. B65D 85/00; C03C 27/12

(52) U.S. Cl. 206/320; 156/99

(57) ABSTRACT

A shell for an electronic device is provided. The shell includes a shell body with an opening formed thereon, and a light transmitting plate mounted onto the shell body to cover the opening. The shell body is formed by hot-pressing at least two layers of carbon fiber fabrics prepreged with a thermosetting resin.

### CROSS REFERENCE TO RELATED APPLICATIONS

present application claim priority to Chinese patent application No. 200810210899.4, filed on Aug. 25, 2008, the entirety of which is hereby incorporated by reference.

### FIELD OF THE INVENTION

The present invention relates to structural improvements of an electronic device, more particularly to a shell for an electronic device, for example, a portable terminal such as a cell phone, PDA, etc, and a method of forming the same.

### BACKGROUND OF THE INVENTION

At present, shell for the electronic device is conventionally made of metal or plastic. A metal shell is formed by press shaping with aluminum alloy, magnesium alloy or stainless steel and so on, the metal shell has exquisite appearance and metallic visual perception, but the weight of electronic device made of metal is added accordingly, and the resistance to abrasion and scratching of metal shell are poor. However, a plastic shell is formed with polycarbonate (PC), acrylonitrile-butadiene-styrene copolymer (ABS) and polycarbonate/acrylonitrile-butadiene-styrene copolymer (PC/ABS) blend resin and so on, the cost of these materials is low whereas the mechanical strength thereof is poor.

### SUMMARY OF THE INVENTION

In viewing thereof, the present invention is directed to solve at least one of the problems existing in the prior art. Therefore, a shell for an electronic device is needed, which is superior in strength with, additionally, aesthetic attractive appearance. Further, a method of forming the same is also needed.

According to an embodiment of the invention, a shell for an electronic device is provided, comprising a shell body with an opening formed thereon, and a light transmitting plate mounted onto the shell body to cover the opening. The shell body may be formed by hot-pressing at least two layers of carbon fiber fabrics prepreged with thermosetting resin.

According to another embodiment of the invention, a method of forming a shell for an electronic device is provided, comprising: 1) prepreging a first at least a layer of carbon fiber fabric, with an opening formed thereon, with thermosetting resin; 2) placing a light transmitting plate on the at least a layer of carbon fiber fabric to cover the opening thereof; 3) placing a second at least a layer of carbon fiber fabric with opening formed thereon prepreged with thermosetting resin over the light transmitting plate, the opening of the second at least a layer of carbon fiber fabric being aligned with the opening of the first at least a layer of the carbon fiber fabric; and 4) performing hot pressing to the first and second at least a layer of carbon fiber fabrics with the light transmitting plate embedded therein to form a shell body of the shell.

In light of the disclosure of the present invention, the shell has a body formed by hot-pressing at least two layers of carbon fiber fabrics prepreged with thermosetting resin, thus the shell is superior in strength. When the shell is further coated with coating layers, the appearance of the electronic device is enhanced with metal visual perception.

Additional aspects and advantages of the embodiments of present invention will be given in part in the following descriptions, become apparent in part from the following descriptions, or be learned from the practice of the embodiments present invention.

### BRIEF DESCRIPTION OF THE DRAWINGS

Therese and other aspects and advantages of the invention will become apparent and more readily appreciated from the following descriptions taken in conjunction with the drawings in which:

FIG. 1 shows a plan view of a shell for an electronic device according to a first embodiment of the present invention;

FIG. 2 shows a cross sectional view along A-A in FIG. 1;

FIG. 3A shows a cross sectional view of the shell before a light transmitting plate is embedded therein according to a first embodiment of the present invention;

FIG. 3B shows a cross sectional view of the shell after a light transmitting plate is embedded therein according to a first embodiment of the present invention; and

FIG. 3C shows a cross sectional view of the shell finally formed according to a first embodiment of the present invention.

### DETAILED DESCRIPTION OF THE EMBODIMENTS

Reference will be made in detail to embodiments of the present invention. The embodiments described herein with reference to drawings are explanatory, illustrative, and used to generally understand the present invention. The embodiments shall not be construed to limit the present invention. The same or similar elements and the elements having same or similar functions are denoted by like reference numerals throughout the descriptions.

According to one embodiment of the present invention, a shell 100 for an electronic device is provided, comprising a shell body 1 with an opening 2 formed thereon, and a light transmitting plate 3 mounted onto the shell body 1 to cover the opening 2. The shell body 1 is formed by hot-pressing at least two layers of carbon fiber fabrics prepreged with thermosetting resin.

For the shell 100 according to the present invention, the thickness of the shell body 1 may be varied if only it is satisfied with the needs of every kind and type of electronic devices, and the thickness of the light transmitting plate 3 may also be varied if only it is satisfied with the needs of every kind and type of electronic devices, for example, the thickness of the shell body 1 may be 0.5-1.5 mm, and the thickness of the light transmitting plate 3 may be 0.5-1.0 mm.

For the shell 100 according to an embodiment of the present invention, the shell 100 may have a plurality layers of carbon fiber fabrics, which are provided at both sides of the light transmitting plate 3 with the light transmitting plate 3 being embedded into the layers thereof to cover the opening 2 formed on the plurality layers of carbon fiber fabrics. The texture directions of every two adjacent layers of carbon fiber fabrics are intersected with each other, by an angle of about 5-90°. In an embodiment of the invention, the angle thereof may be fallen within the range of 30-50°.

For the shell 100 according to an embodiment of the present invention, the texture direction means a running, at least partially, direction of the carbon fiber filaments forming the carbon fiber fabric. The carbon fiber fabric usually includes unidirectional carbon fiber fabric and braided carbon fiber fabric etc.

With regard to the unidirectional carbon fiber fabric, every strand of carbon fiber filaments are arranged in the same direction, then the strands of carbon fiber filaments are adhered together, such as by resin etc, or other material to bond or braid and so on. Thus, the direction in which the strands of carbon fiber filaments are arranged is the direction of the texture direction of the unidirectional carbon fiber fabric.

With regard to the braided carbon fiber fabric, the carbon fiber filaments are arranged in at least two directions, also called weft direction and warp direction, and the strands of the fiber filaments towards different directions are braided to form carbon fiber fabric, such as bidirectional carbon fiber fabric (formed by cross braiding), multi-directional carbon fiber fabric and so on. The staggering of the texture directions in the braided carbon fiber fabric means the staggering of a texture direction by an angle, such as those described hereinabove, with respect to another texture direction.

Through the staggering or intersection of two neighboring layers of the carbon fiber fabric, the pore distribution on the surface of each layer of carbon fiber fabric is uniformized without incurring problems of small pits on the surface of carbon fiber composite products raised by non-uniformed distribution of the thermosetting resin. The non-uniformed distribution of the thermosetting resin is caused by the superposition the layers of carbon fiber fabrics. Without the problem, puttying or polishing process may be avoided or omitted or only slight polishing is needed. Thus, the surface of the shell body 1 made of carbon fiber may also be very even, then the processing steps may be simplified accordingly.

In addition, the carbon fiber fabric and thermosetting resin will distort because of expansion during hot pressing, and the expansion degree of carbon fiber fabric and thermosetting resin are different, then, internal stress is brought and leads some distortion and warp to the shell body 1 made of carbon fiber fabric. When any two neighboring layers of the plurality of carbon fiber fabrics are staggered from each other, the plurality layers of carbon fiber fabrics are more uniform in a thickness direction (for example, the equilibrium method comprises that the texture directions of two adjacent carbon fiber fabric are staggered with each other by an angle of about 5-90°, such as 45°), then at least a part of internal stress may be counteracted in order to reduce the distortion and warp to shell body 1 made of carbon fiber.

When there are a plurality of carbon fiber fabrics, according to an embodiment of the invention, one layer of the carbon fiber fabric is provided at the inner side of the light transmitting plate 3, and the rest layers of carbon fiber fabrics are provided at the outer side of the light transmitting plate 3, for the purpose of fixing the light transmitting plate 3 more stably and preventing the light transmitting plate 3 from falling off when the shell 100 suffers impact or bump.

For the light transmitting plate 3 mounted on the shell body 1 to cover the opening 2 thereof, it may be embedded into the at least two layers of carbon fiber fabrics to cover the opening 2 formed thereon. The light transmitting plate 3 may be made of glass, quartz, resin, Al₂O₃, or plastic, and it may be transparent, translucent or opaque to meet design requirement as conditions may require.

For the shell 100 according to the present invention, the amount of the thermosetting resin used for prepreging the carbon fiber fabric is the amount that the carbon fiber fabric may be saturated. According to an embodiment of the invention, the amount of the thermosetting resin used is 30-60% (wt) of the weight of each layer of the carbon fiber fabric.

The thermosetting resin may be any kind of thermosetting resin normally used in the art, as selected, for example, from at least one of epoxy resin, phenolic resin, urea-formaldehyde resin, melamine resin, unsaturated polyester resin and silicone resin. According to an embodiment of the invention, epoxy resin is used, such as one or more epoxy resin selected from bisphenol-f epoxy resin, bisphenol-a epoxy resin, phenolic epoxy resin, aliphatic epoxy resin and special element epoxy resin (such as organic titanium epoxy resin, organic silicon epoxy resin, organic fluorine epoxy resin and organic phosphorus epoxy resin).

For the shell 100 according to an embodiment of the present invention, the shell 100 further comprises an upper coating layer and a lower coating layer formed on upper and lower sides of the shell body 1 respectively.

The lower coating layer and upper coating layer can provide the shell 100 according to the present invention with attractive façade, such as shinning appearance or colored effect while the surface strength of the shell 100 may also be enhanced. The lower coating layer can fill up the pits that may appear on the shell body 1 made of carbon fiber during the hot pressing. And as an intermediate layer, the lower coating layer can enhance the adhesion between the upper coating layer and the shell body 1 made of carbon fiber. The lower coating layer and upper coating layer may be formed by any kind of primer paints and top paints which are normally used in the art. According to an embodiment of the invention, the lower coating layer may be formed using epoxy resin paint, polyurethane paint or phenolic resin paint, the upper coating layer may be formed using polyurethane paint, acrylate paint, UV paint or any kind of metallic paints commixed with metal particles. The thicknesses of the lower coating layer and upper coating layer may be usual coating thickness, for example, the thickness of the lower coating layer is about 20-50 μm, and the thickness of the upper coating layer is about 15-30 μm.

According to another embodiment of the invention, a method of forming a shell 100 for an electronic device is provided, comprising: 1) prepreging a first at least a layer of carbon fiber fabric, with an opening 2 formed thereon, with thermosetting resin; 2) placing a light transmitting plate 3 on the at least a layer of carbon fiber fabric to cover the opening 2 thereof; 3) placing a second at least a layer of carbon fiber fabric with opening 2 formed thereon prepreged with thermosetting resin over the light transmitting plate 3, the opening 2 of the second at least a layer of carbon fiber fabric being aligned with the opening 2 of the first at least a layer of the carbon fiber fabric; and 4) performing hot pressing to the first and second at least a layer of carbon fiber fabrics with the light transmitting plate 3 embedded therein to form a shell body 1 of the shell.

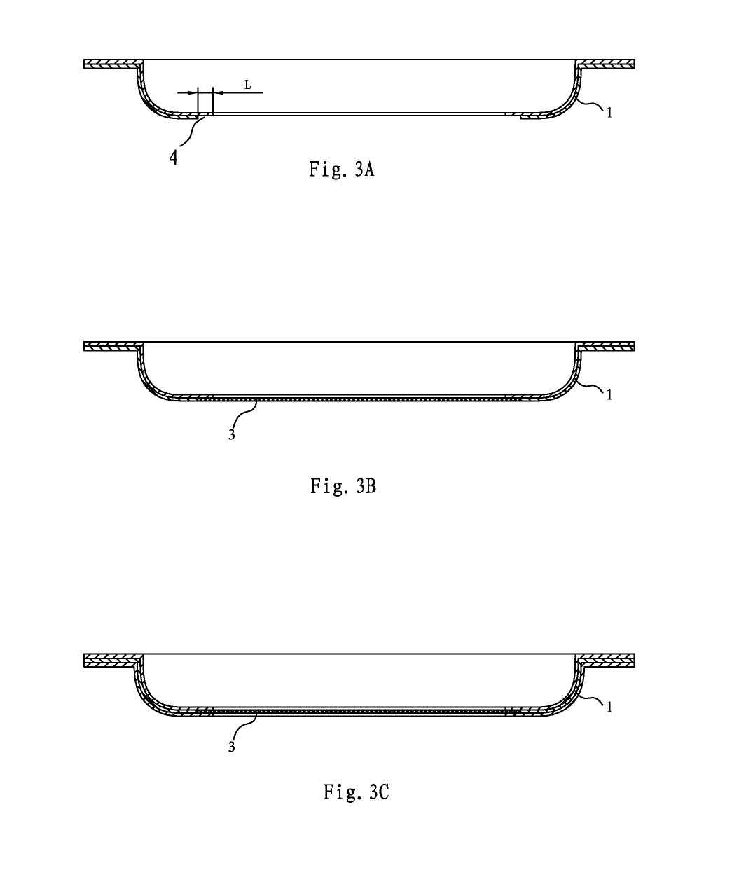

To be specific, according to an embodiment of the invention, the preparing method comprises the steps as follows: (1) the first at least a layer of carbon fiber fabric carbon fiber fabric is prepreged with thermosetting resin, with opening 2 being formed thereon, and the texture directions of every two neighboring layers of the carbon fiber fabrics are staggered with each other; (2) then the first at least a layer of carbon fiber fabric carbon fiber fabric is placed in a preheat-pressing mould. For accommodating the light transmitting plate 3, a recess 4 may be formed by preheat-pressing on the first at least a layer of carbon fiber fabric adjacent the opening 2, thus peripheral edges of the light transmitting plate 3 may be accommodated in the recess accordingly. The recess 4 may have a width L of about 0.5-2 mm as shown in FIG. 3A, and the temperature of the preheat-pressing is about 100-180° C., the pressure of the preheat-pressing is about 1-10 MPa; (3) then, the light transmitting plate 3 is placed in the recess 4 to cover the opening 3 of the first at least a layer of carbon fiber fabric, as shown in FIG. 3B; (4) and the peripheral edges of the light transmitting plate 3 are covered with a second at least a layer of carbon fiber fabric prepreged with thermosetting resin from the other side of the light transmitting plate 3, the opening of the second at least a layer of carbon fiber fabric being aligned with the opening of the first at least a layer of the carbon fiber fabric. Thus, a blank shell body 1 of the shell 100 according to an embodiment of the invention is formed as shown in FIG. 3C; (5) the blank shell body 1 is placed into a hot-pressing mould for performing hot-pressing process. To prevent the light transmitting plate 3 from being damaged due to the pressing during the hot-pressing process, two soft rubber pads are put on the both sides of the light transmitting plate 3, the temperature of hot-pressing is about 120-200° C. and the pressure of the hot-pressing is about 1-20 MPa; and (6) an upper coating layer and a lower coating layer are coated on upper and lower sides of the shell body 1 respectively.

The present invention will be further illustrated by the embodiments hereinafter.

### First Embodiment

In this embodiment, the materials comprise DongLi T300 carbon fiber fabric with a thickness of 0.125 mm, bisphenol-F epoxy resin, a flat glass (thin float glass) with a size of 42.57×32.22×0.57 mm is used as the light transmitting plate 3.

1. Preparation of Shell Body 1 Made of Carbon Fiber

Two sheets or layers of carbon fiber fabric are prepreged into epoxy resin in prepreg machine (Khosla, CD-8048) at room temperature for 1 minute, after the amount of epoxy resin reached 45 (wt) % of the weight of the carbon fiber fabric, the prepreged carbon fiber fabric is cut into parcels of 100 mm×55 mm, with an opening of 39.57×29.22 mm in rectangular shape at the center of the prepreged carbon fiber fabric. Then, the carbon fiber fabric are placed in the hot-pressing mould according to a intersecting angle 45° along the texture direction for hot-pressing in order to obtain edges with a width of 1.6 mm, the temperature of the hot-pressing was about 100° C. and the pressure of the hot-pressing was about 3 MPa.

The light transmitting plate 3 is put into the recess 4 which is formed by hot-pressing, a prepreged carbon fiber fabric containing 45 (wt) % epoxy resin covers the other side of the light transmitting plate 3. The layer of the prepreged carbon fiber fabric is cut according to the size of 100×55 mm, and the recess 4 was cut in the center of the carbon fiber fabric according to a size of 42.57×32.22 mm matching that formed in the above process. Then, a blank shell body 1 made of carbon fiber is obtained.

The blank shell body 1 made of carbon fiber is put into hot-pressing mould for hot-pressing, the temperature for hot-pressing is about 100° C. and the pressure for hot-pressing is about 3 MPa. Two soft rubber pads are put on the both sides of the light transmitting plate 3 in order to prevent the light transmitting plate 3 from being damaged due to the pressure during hot-pressing.

The hot-pressed product is taken out after it is solidified and the mould is cold, the prototype of the shell body 1 made of carbon fiber is obtained. After the residual material of the prototype of the shell body 1 made of carbon fiber is punched off, a shell body 1 made of carbon fiber with a thickness of 0.775 mm is obtained.

2. Forming a Lower Coating Layer and an Upper Coating Layer

The shell body 1 made of carbon fiber obtained above is coated with primer paint (DaBao, RTE-4) and suffered baking-curing process under a temperature of 80° C. to form a lower coating layer with a thickness of 30 μm, then the lower coating layer is polished to be even.

The primer-coated shell body 1 made of carbon fiber is coated with top paint (DaBao, CUV-CO) and is irradiated by UV light with a strength of 800 KJ for 4 seconds in order to form the upper coating layer with thickness of 20 μm.

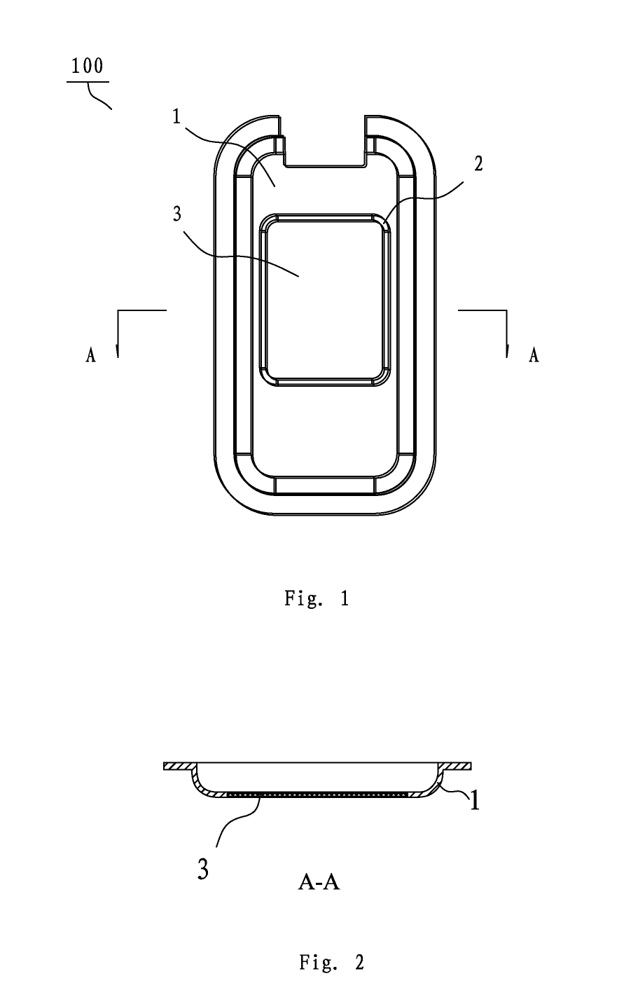

The shell 100 for an electronic device shown in FIG. 1 is obtained finally, wherein, the 1 denoted the light transmitting plate 3 and the 2 denoted the shell body 1 made of carbon fiber.

### Second Embodiment

In this embodiment, the materials comprise DongLi T300 carbon fiber fabric with a thickness of 0.125 mm, bisphenol-A epoxy resin, flat glass (thin float glass) with a size of 42.57×32.22×1 mm is used as the light transmitting plate 3.

1. Preparation of Shell Body 1 Made of Carbon Fiber

Four sheets of carbon fiber fabric are prepreged into epoxy resin in prepreg machine (Khosla, CD-8048) at room temperature for 1 minute, after the amount of epoxy resin reached 55 (wt) % of the weight of each layer of the carbon fiber fabric, the prepreged carbon fiber fabric is cut according to the size of 100×55 mm, and an opening 2 with the size of 39.57×29.22 mm is formed at the center of four layers of the prepreged carbon fiber fabric, then, the carbon fiber fabric are placed in the hot-pressing mould with an intersecting or staggering angle of about 30° along the texture direction for hot-pressing to form the recess 4 with a width L of 0.8 mm, the temperature of the hot-pressing is about 180° C. and the pressure of the hot-pressing is about 1 MPa.

The light transmitting plate 3 is put along the edges of reserved open which is hot-pressed, a prepreged carbon fiber fabric containing 55 (wt) % epoxy resin is provided on the other side of the light transmitting plate 3, the prepreged carbon fiber fabric is cut according to the size of 100 mm×55 mm, and the opening 2 is formed at the center of the layer of the carbon fiber fabric according to a size of 42.57×32.22 mm. Then, a blank shell body 1 made of carbon fiber is obtained.

The blank shell body 1 made of carbon fiber is put into hot-pressing mould for hot-pressing, the temperature for hot-pressing is about 180° C. and the pressure for hot-pressing is about 1 MPa. Two soft rubber pads are put on the both sides of the light transmitting plate 3 in order to prevent the light transmitting plate 3 from being damaged due to the pressure during hot-pressing.

The hot-pressed product is taken out after it is solidified and the mould is cold, the prototype of the shell body 1 made of carbon fiber is obtained. After the residual material of the prototype of the shell body 1 made of carbon fiber is punched off, a shell body 1 made of carbon fiber with a thickness of 1.4 mm is obtained.

2. Forming a Lower Coating Layer and an Upper Coating Layer

The shell body 1 made of carbon fiber obtained as described hereinabove is coated with primer paint (DaBao, RTE-4) and undertakes baking-curing process under a temperature of about 80° C. to form a lower coating layer with a thickness of 20 μm, then the lower coating layer is polished to be more even.

The primer-coated shell body 1 made of carbon fiber is coated with top paint (DaBao, CUV-CO) and is irradiated by UV light with strength of 800 KJ for 4 seconds in order to form an upper coating layer with thickness of 15 μm.

Finally, the shell 100 for an electronic device is obtained.

### Third Embodiment

In this embodiment, the materials comprise DongLi T300 carbon fiber fabric with thickness of 0.125 mm, bisphenol-A epoxy resin, flat glass (thin float glass) with a size of 42.57×32.22×0.57 mm is used as the light transmitting plate 3.

1. Preparation of Shell Body 1 Made of Carbon Fiber

One sheet or layer of carbon fiber fabric is prepreged into epoxy resin in prepreg machine (Khosla, CD-8048) at room temperature for 1 minute, after the amount of epoxy resin reached 35 (wt) % of the weight of the layer of the carbon fiber fabric, the prepreged carbon fiber fabric is cut according to a size of 100 mm×55 mm, with an opening 2 of a size of 39.57 mm×29.22 mm being formed at the center of the layer of prepreged carbon fiber fabric. Then, the layer of carbon fiber fabric is put in the hot-pressing mould according to a intersecting angle 50° along the texture direction for hot-pressing to form the recess 4 with a width L of 2 mm, the temperature of the hot-pressing is about 150° C. and the pressure of the hot-pressing is about 9 MPa.

The light transmitting plate 3 is accommodated into the recess 4 which is formed by hot-pressing, then another layer of a prepreged carbon fiber fabric containing 35 (wt) % epoxy resin is provided on the other side of the light transmitting plate 3, the prepreged carbon fiber fabric is cut according to the size of 100×55 mm, and the opening 2 is cut at the center of the carbon fiber fabric according to a size of 42.57×32.22 mm. Then, a blank shell body 1 made of carbon fiber is obtained.

The blank shell body 1 made of carbon fiber is put into a hot-pressing mould for hot-pressing, the temperature for hot-pressing is about 150° C. and the pressure for hot-pressing is about 9 MPa. Two soft rubber pads are put on the both sides of the light transmitting plate 3 in order to prevent the light transmitting plate 3 from being damaged due to the pressure during hot-pressing.

The hot-pressed shell is taken out after it is solidified and the mould is cold, the prototype of the shell body 1 made of carbon fiber is obtained. After the residual material of the prototype of the shell body 1 made of carbon fiber is punched off, a shell body 1 made of carbon fiber with a thickness of 0.6 mm is obtained.

2. Forming a Lower Coating Layer and an Upper Coating Layer

The shell body 1 made of carbon fiber obtained above is coated with primer paint (DaBao, RTE-4) and undertakes baking-curing process under a temperature of about 80° C. to form a lower coating layer with a thickness of 50 μm, then the lower coating layer is polished to be more even.

The primer-coated shell body 1 made of carbon fiber is coated with top paint (DaBao, CUV-CO) and is irradiated by UV light with a strength of 800 KJ for 4 seconds in order to form an upper coating layer with a thickness of 30 μm. Finally, the shell 100 for an electronic device is obtained.

### Comparative Embodiment

A conventional shell for an electronic device with light transmitting plate is formed in this comparative embodiment.

In this comparative embodiment, the materials comprises polycarbonate/acrylonitrile-butadiene-styrene (PC/ABS) blend resin (GEC1200HF), transparent poly methyl methacrylate (PMMA) resin (Degussa Plexiglas 8N) with a size of 42.57×32.22×0.57 mm is used as the light transmitting plate.

1. Preparation of a PMMA Light Transmitting Plate

The transparent PC/ABS particles are roasted in the circulating hot air oven under a temperature of 100° C. for 3 hours, and then the PC/ABS particles are molded into a mobile phone shell with injection molding machine (Sumitomo SE130DU) when the injection pressure is about 80 MPa, the melting temperature is about 240° C. and the mold temperature is about 55° C.

2. Preparation of a Mobile Phone Shell

The black PC/ABS particles are roasted in the circulating hot air oven under a temperature of 100° C. for 3 hours, and then the PC/ABS particles are molded into a mobile phone shell with injection molding machine (Sumitomo SE130DU) when the injection pressure is about 80 MPa, the melting temperature is about 270° C. and the molding temperature is about 70° C.

3. Coating the Mobile Phone Shell

The surface of the mobile phone shell is coated with UV paint (Cashew 3600-30002M) and the coat is irradiated by UV light with a strength of 800 KJ for 4 seconds in order to form an upper coating layer with a thickness of 20 μm.

4. Assembling of the Mobile Phone Shell

The transparent PMMA light transmitting plate and the coated mobile phone shell are welded using ultrasonic at a frequency of 20 KHz.

Finally, the shell for an electronic device is obtained.

Mechanical Properties Tests

1. Mechanical Strength Testing

The tensile strength, tensile modulus, bending strength, bending modulus and notched impact strength of the embodiments in the present invention are tested according to GB/T 1040-2006.

The shells for an electronic device formed according to the embodiments 1-3 and the comparative embodiment are tested as described above, and testing results are shown in table 1 as follows.

TABLE 1

| | Samples | | | | | | | |
|---|---|---|---|---|---|---|---|---|
| | Embodiment | | Embodiment | | Embodiment | | Comparative | |
| Properties | 1 | | 2 | | 3 | | Embodiment | |
| Tensile | 650 | MPa | 680 | MPa | 635 | MPa | 57 | MPa |
| strength | | | | | | | | |
| Tensile | 4400 | MPa | 4358 | MPa | 4486 | MPa | 2270 | MPa |
| modulus | | | | | | | | |
| Bending | 1465 | MPa | 1542 | MPa | 1384 | MPa | 88 | MPa |
| strength | | | | | | | | |
| Bending | 7600 | MPa | 7524 | MPa | 7685 | MPa | 2340 | MPa |
| modulus | | | | | | | | |
| Notched | 1360 | KJ/m² | 1245 | KJ/m² | 1286 | KJ/m² | 74 | KJ/m² |
| impact | | | | | | | | |
| strength | | | | | | | | |

As shown in table 1, the shell for an electronic device provided according to the present invention has high tensile strength accordingly.

Although explanatory embodiments have been shown and described, it would be appreciated by those skilled in the art that changes, alternatives, and modifications may be made in the embodiments without departing from spirit and principles of the invention. Such changes, alternatives, and modifications all fall into the scope of the claims and their equivalents.

1. A shell for an electronic device comprising:
a shell body with an opening formed thereon; and
a light transmitting plate mounted onto the shell body to cover the opening, wherein the shell body is formed by hot-pressing at least two layers of carbon fiber fabrics prepreged with a thermosetting resin.

2. The shell according to claim 1, wherein peripheral edges of the light transmitting plate are embedded into the shell body.

3. The shell according to claim 1, wherein the light transmitting plate includes at least one of glass, quartz, resin, Al₂O₃, or plastic.

4. (canceled)

5. The shell according to claim 1, wherein each side of the light transmitting plate is provided with at least a layer of carbon fiber fabric respectively.

6. The shell according to claim 5, wherein texture directions of neighboring carbon fiber fabrics are intersected or staggered with each other by an angle of about 5-90°.

7. The shell according to claim 6, wherein the intersecting or staggering angle is about 30-50°.

8. The shell according to claim 1, wherein amount of the thermosetting resin used in prepreging is about 30-60% (wt) of a weight of each layer of carbon fiber fabric respectively.

9. The shell according to claim 1, wherein the thermosetting resin is selected from at least one of epoxy resin, phenolic resin, urea-formaldehyde resin, melamine resin, unsaturated polyester resin or silicone resin.

10. The shell according to claim 1, further comprising an upper coating layer and a lower coating layer formed on upper and lower sides of the shell body respectively, and wherein a thickness of the lower coating layer is about 20-50 μm, a thickness of the upper coating layer is about 15-30 μm.

11. The shell according to claim 1, wherein a thickness of the shell body is about 0.5-1.5 mm, and wherein a thickness of the light transmitting plate is about 0.5-1 mm.

12. A method of forming a shell for an electronic device, comprising:
1) prepreging at least one first layer of carbon fiber fabric with a first thermosetting resin, the at least one first layer having an opening formed thereon;
2) placing a light transmitting plate on the at least one first layer of carbon fiber fabric to cover the opening thereof;
3) placing at least one second layer of carbon fiber fabric with opening formed thereon prepreged with a second thermosetting resin over the light transmitting plate, an opening of the at least one second layer of carbon fiber fabric being aligned with the opening of the at least one first layer of carbon fiber fabric; and
4) performing hot pressing to the at least one first layer of carbon fiber fabric and the at least one second layer of carbon fiber fabric with the light transmitting plate embedded therebetween to form a shell body of the shell.

13. The method according to claim 12,
wherein texture directions of neighboring first layers of the carbon fiber fabrics are intersected or staggered with each other by a first angle of about 5-90° and
wherein texture directions of neighboring second layers of carbon fiber fabrics are intersected or staggered with each other by a second angle of about 5-90°.

14. (canceled)

15. The method according to claim 13, wherein the first or second angle is about 30-50° respectively.

16. The method according to claim 12, wherein amount of the thermosetting resin used in prepreging is about 30-60% (wt) of a weight of each layer of the at least one first or second layer of carbon fiber fabric respectively.

17. The method according to claim 12, wherein the hot pressing is performed under a temperature of about 120-200° C. with a pressure of about 1-20 MPa with rubber pads being provided on each side of the light transmitting plate for preventing cracking thereof.

18. The method according to claim 12, further comprising:
coating an upper coating layer and a lower coating layer on upper and lower sides of the shell body with thicknesses of 20-50 μm and 15-30 μm respectively.

19. The method according to claim 12, the step 1) further comprising:
forming a recess on the at least one first layer of carbon fiber fabric adjacent the opening formed on the at least one first layer to accommodate peripheral edges of the light transmitting plate.

20. The method according to claim 17, wherein the hot pressing is performed under a temperature of about 100-180° C. with a pressure of about 1-10 MPa.

21. The method according to claim 12, wherein the thermosetting resin is selected from at least one of epoxy resin, phenolic resin, urea-formaldehyde resin, melamine resin, unsaturated polyester resin or silicone resin.

22. The method according to claim 12, wherein the light transmitting plate includes at least one of glass, quartz, resin, Al₂O₃, or plastic.
